(19) United States
(12) Patent Application Publication
(10) Pub. No.: US 2016/0285599 A1
(43) Pub. Date: Sep. 29, 2016

(54) DEVICES, SYSTEMS, AND METHODS FOR IP BASED BROADBAND WIRELESS COMMUNICATION SYSTEMS

(71) Applicant: Full Spectrum Inc., Sunnyvale, CA (US)

(72) Inventor: Menashe SHAHAR, Los Altos, CA (US)

(21) Appl. No.: 15/081,406

(22) Filed: Mar. 25, 2016

Related U.S. Application Data
(60) Provisional application No. 62/139,290, filed on Mar. 27, 2015.

(51) Int. Cl. H04L 5/00; H04L 12/28

(52) U.S. Cl. CPC H04L 5/0007; H04L 12/2861

(57) ABSTRACT

An Internet Protocol (IP) based communication system for transmitting and receiving data on a broadband wireless network that includes at least one base station and a plurality of remote stations capable of transmitting and receiving data. The data is encapsulated in Time Division Duplex (TDD) frames and represented by Orthogonal Frequency Division Multiple Access (OFDMA) symbols using a nominal channel bandwidth of less than 1.25 Megahertz.

### CROSS REFERENCE TO RELATED APPLICATION

This application claims priority to and the benefit of U.S. provisional patent application No. 62/139,290, filed on Mar. 27, 2015, the entire contents of which are incorporated herein by reference.

### FIELD OF THE INVENTION

The invention relates generally to Point to Multipoint (PtMP) Broadband Wireless Systems having Base Stations (BSs) and Remote fixed and mobile Stations (RSs). In particular, the invention relates to a physical layer the PtMP Broadband Wireless network that employs Time Division Duplex (TDD) and Orthogonal Frequency Division Multiple Access (OFDMA) for a network that uses a nominal channel bandwidth of less than 1.25 Megahertz.

### BACKGROUND

Point to Multipoint (PtMP) Broadband Wireless Systems can include base stations (BS), remote stations (fixed or mobile) (RS) for example, to provide a network for broadband access to multiple users per BS. Every BS can communicate with one or more RSs that are located at varying distances from the BS. The BS to which a RS is connected can be referred to as its parent BS. A BS with all RSs connected to it can be referred to as a sector.

BSs and RSs communication can employ a time division duplex (TDD) frame scheme. The TDD frames can consist of multiple sections, for example, a Downlink Sub Frame (DLSF), an Uplink Sub Frame (ULSF), a Transmit to Receive Gap (TRG), a Receive to Transmit Gap (RTG), or any combination thereof. Transmissions from the BSs to RSs are typically done within the DLSF and transmissions from the RSs to BSs are typically done within ULSF.

PtMP Broadband Wireless Systems can also use Orthogonal Frequency Division Multiple Access (OFDMA). An OFDMA symbol can include all eligible subcarriers used in the respective OFDMA scheme and/or one or more subsets of all eligible subcarriers (e.g., sub-channel”). An example of the number of subcarriers per OFDMA symbols include 128, 512, and/or 1024 sub-carriers. An example of a subset of all eligible subcarriers for a sub-channel are 18 subcarriers.

PtMP Broadband Wireless Systems can operate across a variety of nominal channel bandwidths. For example, when operating a private network, network owners can acquire licenses for frequencies that are available. Typical ranges of bandwidths that is available for licensing for private wireless communication networks below 1 GHz in the U.S. for example, are between 1.0 Megahertz and 100 Kilohertz wide.

PtMP Broadband Wireless Systems can comply with various broadband wireless standards (e.g., IEEE 802.16). These standards can include physical layer specifications. The physical layer of modern internet protocol (IP) based, broadband wireless standards (e.g., 4G) designed for high speed data communication, can employ a channel bandwidth over a 1.25 Megahertz. Application of the physical layer parameters defined in these standards to networks employing TDD frames with OFDMA symbols and channel bandwidth below 1.25 Megahertz can result in very low throughput and high latency.

Therefore, it can be desirable to design a physical layer which will support high performance operation for a network with a channel bandwidth below 1.25 Megahertz. Given the range of channel bandwidth (e.g., 100 KHz to 1.25 MHz), it is desirable for a physical layer scheme to have the flexibility to be configured for each specific channel

### SUMMARY OF THE INVENTION

Advantages of the invention can include a physical layer that allows for high speed, Internet Protocol (IP) based communication with a channel bandwidth below 1.25 Megahertz. Other advantages of the invention can include a physical layer configuration that allows for flexibility for the nominal channel bandwidth of the network. Other advantages of the invention can include a physical layer that supports high throughput and low latency performance when operating in a narrow channel bandwidth scenario.

Additional advantages of the invention can include the flexibility to support any downlink to uplink ratio (DL:UL) ratio including an extreme reverse asymmetrical DL:UL ratio, e.g., most of the TDD frame is used for RS to BS communication. Extreme reverse asymmetrical traffic scenarios are typical in SCADA applications.

The use of narrow channel for private broadband wireless communication reduces the cost of frequency acquisition and the infrastructure cost (e.g., due to an improved DL:UL ratio).

In one aspect, the invention includes a communication system for transmitting and receiving data on a broadband wireless network. The system includes at least one base station capable of transmitting and receiving data the data encapsulated in Time Division Duplex (TDD) frames and represented by Orthogonal Frequency Division Multiple Access (OFDMA) symbols, wherein said base station transmits data in a downlink sub-frame of one or more of the TDD frames and receives data in carried in an uplink sub-frame of one or more of the TDD frames. The system also includes a plurality of remote stations capable of communicating data with the at least one base station, wherein said remote stations transmit data to said at least one base station in the uplink sub-frame of one or more of the TDD frames and receive data from said at least one base station in the downlink sub-frame of one or more the TDD frames. The at least one base station and each of said plurality of remote stations communicate using a nominal channel bandwidth of less than 1.25 Megahertz.

In some embodiments, at least one of the TDD frames a downlink duration for its corresponding downlink sub-frame is at least two times an uplink duration for its corresponding uplink sub-frame. In some embodiments, at least one of the TDD frames an uplink duration for its corresponding uplink sub-frame is at least two times a downlink duration for its corresponding downlink sub-frame.

In some embodiments, the data is transmitted and received such that i) a number of active subcarriers is minimized such that the pilot subcarrier spacing is less than or equal to the coherent bandwidth, wherein the coherent bandwidth is based on the a delay spread of the channel, and ii) a percentage of pilot subcarriers relative to a total number of subcarriers should be low to avoid excessive overhead.

In some embodiments, a total number of active subcarriers is based on the total number of subcarriers, minus a number of guard subcarriers on a left edge of the channel, and minus a number of guard subcarriers on a right edge of the channel. In some embodiments, the number of guard subcarriers on the left edge of the channel and the number of guard subcarriers on the right edge of the channel is based on one or more spectrum emission requirements.

In some embodiments, the data is transmitted and received with a sampling frequency that results in a number of TDD frames within 1 second to be an integer. In some embodiments, the data is transmitted and received such that a subcarrier spacing is less than a delay spread of the channel. In some embodiments, the frame duration for the TDD frames is based on a desired latency and a desired throughput. In some embodiments, an integer number of frames needs to fit in an integer multiple of one second. This can allow aligning a beginning of some of the TDD frames with a GPS synchronized 1 PPS signal.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 is a diagram of an exemplary wireless system, according to an illustrative embodiment of the invention.

### DETAILED DESCRIPTION OF EMBODIMENTS OF THE INVENTION

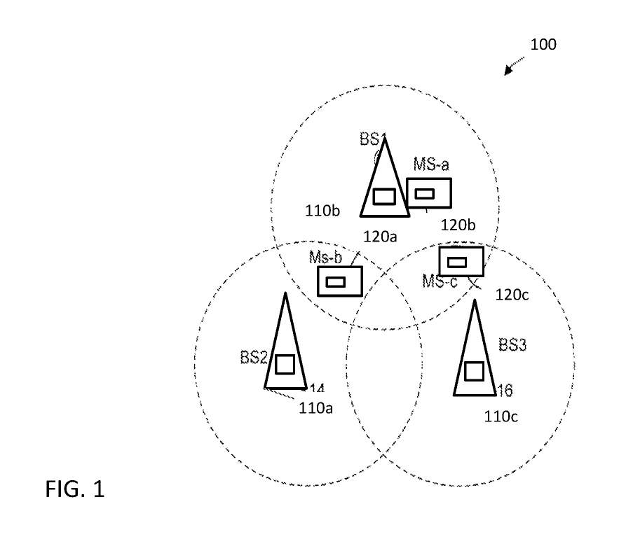

FIG. 1 is a diagram of an exemplary wireless system 100, according to an illustrative embodiment of the invention. The wireless system 100 includes towers 110a, 110b, 110c, generally, 110, and remote stations 120a, 120b, 120c, generally 120. It will be understood that remote stations may be fixed or mobile remote stations. It will further be understood that one or more BS 110 may reside in a single tower.

The exemplary wireless system 100 can be a WIMAX system, LTE system, or any other broadband system as is known in the art. The wireless system 100 can be internet protocol (IP) based. The wireless system 100 can be packet-switched.

The base stations (BSs) 110 can communicate with the remote stations (RSs) 120. The communication from the BSs 110 to the RSs 120 can be referred to as a downlink. The communication from the RSs 120 to the BSs 110 can be referred to as an uplink.

The BSs 110 and/or the RSs 120 can include a GPS synchronized clock as a reference to its respective sampling clock and/or TDD framing. The TDD frames can consist of sections, for example, a Downlink Sub Frame (DLSF), an Uplink Sub Frame (ULSF), a Transmit to Receive Gap (TRG), a Receive to Transmit Gap (RTG), or any combination thereof. In various embodiments, there is a single AMC zone in the DLSF and/or the ULSF.

Duration of each section of the TDD frame can be configurable. The TDD configuration can be based on traffic characteristics, latency and/or distance. In some embodiments, the TDD frame duration between 5 milliseconds and 50 ms.

Any of the BSs 110 can communicate with any of the RSs 120 within a service area of the particular BSs 110. In various embodiments, the service area is within a 40 mile radius. In some embodiments, a minimum necessary gaps overhead value and/or gaps duration in samples value is configured based on the service area and/or a sampling clock.

Traffic Characteristics: for a symmetrical traffic application (e.g., Voice over Internet Protocol), the DLSF and the ULSF can have an equal duration. For an asymmetrical traffic application (e.g., web browsing), the DLSF can be large and the ULSF can be small (e.g., a DLSF duration of 8 milliseconds and a ULSF duration is 2 milliseconds). For a reverse asymmetrical traffic application e.g., web hosting, the DLSF can be small and the ULSF can be large.

In some embodiments, a ratio of the duration of the DLSF to the duration of ULSF is asymmetrical. The asymmetrical configuration can allow for double the throughput for Supervision Control And Data Acquisition (SCADA) applications relative to frequency division duplex (FDD). In some embodiments, the duration of DLSF is twice the duration of the ULSF. In some embodiments, the duration of the ULSF is twice the duration of the DLSF. In some embodiments, a DLSF duration/ULSF duration ratio is 1:10. In some embodiments, the DLSF duration/ULSF duration ratio is 10:1.

Transmission between the BSs 110 and the RSs 120 can be done in according with TDD framing. The data in the transmission can be transmitted in accordance with OFDM/OFDMA.

In some embodiments, the eligible subcarriers within a sector can be all subcarriers used in the respective OFDMA scheme and/or one or more of a subset of all subcarriers (e.g., “sub-channel”). Exemplary OFDMA schemes include 128, 512, and/or 1024 sub-carriers.

The exemplary wireless system 100 can be configured such that operation occurs with a nominal channel bandwidth less than 1.25 kilohertz. In some embodiments, the exemplary wireless system 100 operates with a bandwidth between 1.25 kilohertz and 100 kilohertz. In some embodiments, the nominal channel bandwidth is 1 megahertz, 500 kilohertz, 125 kilohertz, or 1.0 megahertz.

In various embodiments, physical layer parameters for the exemplary wireless system 100 are configured based on the nominal channel bandwidth (for example, as is described in further detail below).

In some embodiments, the data is transmitted and/or received in accordance with a band AMC subcarrier allocations scheme. In these embodiments, the data is transmitted and/or received such that there are adjacent subcarriers per sub-channel. In some embodiments, the number of sub-channels is reduced based on the nominal channel bandwidth. In some embodiments, the number of sub-channels is reduced to allow for frequency re-use. In these embodiments, the number of sub-channels is reduced to allow for frequency re-use of (1,3,3) or (1,3,1). For example, a nominal channel bandwidth of 1.0 megahertz has 6 AMC 2X3 sub-channels. For a nominal channel bandwidth of 500 kilohertz, only 3 of the AMX 2X3 sub channels is used. In this example, a sampling clock and/or subcarrier spacing for the nominal channel bandwidth of 500 kilohertz can remain the same as for the nominal channel bandwidth of 1.0 kilohertz.

In some embodiments, the data is transmitted and/or received such that a sampling clock is modified. The sampling clock can be reduced based on the nominal channel bandwidth. For example, for a nominal channel bandwidth of 125 kilohertz, the sampling clock can be approximately 560 kilohertz and subcarrier spacing can be approximately 4.4375 kilohertz. In another example, for a nominal channel bandwidth of 100 kilohertz, the sampling clock can be approximately 448 kilohertz and the subcarrier spacing can be 3.5 kilohertz.

In some embodiments, the data is transmitted and/or received such that a subcarrier spacing does not exceed the coherent bandwidth, wherein the coherent bandwidth is based on a delay spread of the nominal channel bandwidth, and a total number of subcarriers is based on the subcarrier spacing.

In some embodiments, data is transmitted and/or received in accordance with various physical layer parameter configurations.

The physical layer parameter of a Nominal Channel bandwidth BW_{N} can be the bandwidth for a network (e.g., exemplary broadband network 100). The nominal channel bandwidth BW_{N} can be specified by a user (e.g., in the case of a private network). The nominal channel bandwidth BW_{N} can be a particular bandwidth allocated by the FCC for a particular network. The nominal channel bandwidth BW_{N} can be a particular bandwidth allocated by any regulatory body (e.g., regulatory bodies in Europe, China, Japan, India, etc.) for a particular network.

The physical layer parameter of a number of guard subcarriers on a left edge of a channel N_{GL} can be based on a desired spectrum emission mask (e.g., the FCC or other regulatory body spectrum emission mask requirements).

The physical layer parameter of a number of guard subcarriers on a right edge of the channel N_{GR} can be based on a desired spectrum emission mask (e.g., the FCC or other regulatory body spectrum emission mask requirements).

The physical layer parameter of a total number of subcarriers N_{SCa} can be based on a Fast Fourier Transform (FFT) size of particular OFDM/OFDMA implementation in the network. In some embodiments, the total number of subcarriers N_{SCa} is based on a subcarrier spacing. In various embodiments, the total number of subcarriers N_{SCa} is 64, 128, 512, 1024, or 2,048.

The physical layer parameter of a number of active subcarriers N_{ASCa} can be based on the total number of subcarriers N_{SC}, the number of guard carriers on the right edge N_{GR} and the number of guard carries on the left edge N_{GL}.

In some embodiments, the number of active subcarriers N_{ASCa} is determined as follows:

N_{ASCa}=N_{SCa}−(N_{GL}+N_{GR}) EQN. 1

For example, if the total number of subcarriers N_{SCa} is 128 and the number of total guard subcarriers on the left and right edge. N_{GL}, N_{GR}, respectively, is 20, the number of active subcarriers N_{ASCa} is 108.

The physical layer parameter of a sampling frequency F_{S} can be based on the sample duration. In some embodiments, the sampling frequency F_{S} is determined as follows:

F_{S}=1/T_{S} EQN. 2

where T_{S} is the sample duration. In some embodiments, the sampling frequency F_{S} is greater than the nominal channel bandwidth BW_{N}. In some embodiments, the sampling frequency F_{S} is selected such that the number of samples per frame is an integer. In various embodiments, the sampling frequency F_{S} is 0.56 MHz, 1.12 MHz, 1.4 MHz or 5.6 MHz.

The physical layer parameter of a sample duration T_{S} can be based on the sampling frequency F_{S}. In some embodiments, the sampling duration T_{S} is determined as follows:

T_{S}=1/F_{S} EQN. 3

The physical layer parameter of an actual channel bandwidth BW_{A} can be based on the sampling frequency F_{S}, the number of active subcarriers N_{ASCa}, and the total number of subcarriers N_{SCa}. In some embodiments, the actual channel bandwidth BW_{A} is determined as follows:

BW_{A}=F_{S}×N_{ASCa}/N_{SCa} EQN. 4

For example, if the sampling frequency F_{S} is 1,120 kilohertz, the number of active subcarriers N_{ASCa} is 108 and the total number of subcarriers N_{SC}, is 128, the actual channel bandwidth BW_{A} is 945 KHz.

The physical layer parameter of a subcarrier spacing BW_{SC} can be less than the coherent bandwidth. The coherent bandwidth can be determined by the delay spread of the channel. In some embodiments, the subcarrier spacing BW_{SC} is determined as follows:

BW_{SC}=F_{S}/N_{SCa}=BW_{A}/N_{ASCa} EQN. 5

For example, if the sampling frequency F_{S} is 1.120 kilohertz and the number of active subcarriers N_{SC}, is 128, the subcarrier spacing BW_{SC} is 8.75 KHz.

The physical layer parameter of a cyclic prefix CP can be used to mitigate multipath. In some embodiments, a duration of the cyclic prefix CP is a fraction of the useful symbol time, e.g., ⅛ and 1/16. In some embodiments, the duration of the cyclic prefix CP exceeds the highest anticipated delay spread.

The physical layer parameter of a total number of samples per symbol N_{SaPS} can be based on the total number of active subcarriers N_{SCa} and the cyclic orefix CP. In some embodiments, total number of samples per symbol N_{SaPS} is determined as follows:

N_{SaPS}=N_{SCa}(1+CP) EQN. 6

The physical layer parameter of a frame duration T_{F} can be based the maximum allowed end to end data transmission latency between BS and RS. In some embodiments, the frame duration T_{F} is inversely proportional to the latency. In some embodiments, the frame duration T_{F} is based on required channel data throughput. In some embodiments, the frame duration T_{F} is 5 ms, 10 ms, 12.5 ms, 15 ms, 20 ms, 25 ms, 40 ms, or 50 ms.

The physical layer parameter of the minimum number of frames required to fit in an integer multiple of one second N_{F} can be based on GPS synchronization. For example, GPS synchronization can require alignment of a beginning of a TDD frame with a 1 PPS signal, every couple of seconds. For example, if the TDD frame duration is 10 ms, an alignment of the beginning of a frame with the 1 PPS signal can be met every 100 frames, e.g., every second. If the frame duration is 15 ms, an alignment of the beginning of a frame with the 1 PPS signal can be met every 200 frames, e.g., every 3 seconds.

The physical layer parameter of a total gap duration T_{GAP} can be based on the maximal distance between BS and RS. In some embodiments, two gaps are defined; TRG: The gap between an end of a TDD transmit sub-frame and a beginning of the TDD receive sub-frame. RTG: This gap is used between the end of the receive sub-frame and the beginning of the transmit sub-frame. In some embodiments, the total gap duration is the sum of the RTG and TRG.

For example, the gaps can be defined as follows: a base station TRG gap, BS_TRG, a base station RTG gap, BS_RTG, a remote station TRG, RS_TRG, and remote station RTG. RS_RTG. In some embodiments, BS_TRG+BS_RTG=RS_TRG+RS_RTG. In some embodiments. BS_TRG is greater than the combination of a transmit to receive switching delay and a maximum round trip delay (RTD) to the remote stations. In some embodiments. BS_RTG is greater than a receive to transmit switching delay. In some embodiments, RS_RTG=BS_TRG−RTD.

The physical layer parameter of a total number of samples per gap N_{GP} can be based on the total gap T_{GAP} and sample duration T_{S}. In some embodiments, the total number of samples per gap N_{GAP} is determined as follows:

N_{GAP}=T_{GAP}/T_{S} EQN. 7

The physical layer parameter of a number of samples per frame N_{SaPF} can be based on the frame duration T_{F} and the sample duration T_{S}. In some embodiments, the total number of samples per frame N_{SaPF} is determined as follows:

N_{SaFP}=T_{F}/T_{S} EQN. 8

The physical layer parameter of a number of symbols per frame N_{SyPF} can be an integer number. In some embodiments, the total gap T_{GAP} is increased to cause the number of symbols per frame N_{SyPF} to be an integer number. In some embodiments, the number of symbols per frame N_{SyPF} is based on the total number of samples per gap N_{GAP} and the number of samples per frame N_{SaPF}. In some embodiments, number of symbols per frame N_{SyPF} is determined as follows:

N_{SyPF}=(N_{SaPF}−N_{GAP})/N_{SaPS} EQN. 9

The physical layer parameter of a frequency reuse Nᵣₑᵤₛₑ can be determined for the uplink and the downlink. In some embodiments, the frequency reuse Nᵣₑᵤₛ in the uplink and/or downlink is based on a number of orthogonal resources in the uplink and/or downlink. respectively. In some embodiments, the number of orthogonal resources, respectively, is based on one or more sub-channels that are allocated to a single sector. For example, Nᵣₑᵤₛₑ=3 can imply there are 3 orthogonal resources that can each be used in one sector of a 3 sector tower. In some embodiments, the frequency resuse Nᵣₑᵤₛₑ has the same value in the downlink as the uplink. In some embodiments, the frequency reuse Nᵣₑᵤₛₑ has different values in the downlink as the uplink.

The physical layer parameter of a maximum number of sub-channels required per sector N_{SChPS} can be based on the number of remote stations per sector. In a Point to Multipoint sector, each sub-channel can be used by one remote station at one time. When one sub-channel is used per remote station, the multiple access mechanism can be single dimensional time division. Transmit/Receive of multiple remote stations at substantially the same time can require multiple sub-channels, where the number of remote stations operating at the same time equals the number of the sub-channels in the sector. For multiple sub-channels is used per remote station, the multiple access mechanism can be two dimensional, time and frequency.

The physical layer parameter of a total number of sub-channels N_{SCh} can be based on the frequency resuse Nᵣₑᵤₛₑ and the maximum number of sub-channels required per sector N_{SChPS} In some embodiments, the total number of sub-channels N_{SCh} is determined as follows:

N_{SCh}=Nᵣₑᵤₛₑ×N_{SChPS} EQN. 10

The physical layer parameter of a number of subcarriers per sub-channel per symbol N_{SCaPSCh} can be based on the number of active subcarriers N_{ASCa} and the total number of sub-channels N_{SCh}. In some embodiments, number of subcarriers per sub-channel per symbol N_{SCaPSCh} is determined as follows:

N_{SCaPSCh}=(N_{ASCa}−1)/N_{SCh} EQN. 11

Subtracting 1 from N_{ASCa} can account for the null DC subcarrier. In some embodiments, the number of subcarriers per sub-channel per symbol N_{SCaPSCh} is an integer number. In some embodiments, number of guard subcarriers on the left edge N_{GL}, and number of guard subcarriers on the right edge N_{GR} are increased, which can decrease the number of active subcarriers N_{ASCa}, to cause the number of subcarriers per sub-channel per symbol N_{SCaPSCh} to be an integer number.

The physical layer parameter of a number of pilot subcarriers per sub-channel per symbol N_{PiPSCa} can be void. For example, the number of pilot subcarriers per sub-channel per symbol N_{PiPSCa} can be void of data. In some embodiments, the number of pilot subcarriers per sub-channel per symbol N_{PiPSCa} are minimized. In some embodiments, the number of pilot subcarriers per sub-channel per symbol N_{PiPSCa} are minimized, by for example, allocating the pilots at equal frequency spacing. In some embodiments, the pilot spacing is less than the coherent bandwidth. The coherent bandwidth can be based on the delay spread.

The physical layer parameter of a number of data subcarriers per sub-channel N_{DaPSCa} can be based on the number of pilot subcarriers per sub-channel per symbol N_{PiPSCa} and number of subcarriers per sub-channel per symbol N_{SCaPSCh}. In some embodiments, number of data subcarriers per sub-channel N_{DaPSCa} is determined as follows:

N_{DaPSCa}+N_{PiPSCa}=N_{SCaPSCh} EQN. 12

The physical layer parameter of a number of symbols per slot N_{Slot} can be based on the number of symbols within one sub-channel. The number of symbols per slot N_{Slot} can be the smallest entity of bandwidth allocation. In some embodiments, the number of symbols per slot N_{Slot} can be 1, 2, or 3 symbols. In some embodiments, the number of symbols per slot N_{Slot} is based on overhead associated with extra bandwidth required to align the PDUs with the slot boundary.

The physical layer parameter of a subcarrier index can be a logical identification of each of the N_{SCa} subcarriers. For example, for 128 FFT, the subcarrier indexes can be between 1 and 128.

The physical layer parameter of a subcarrier allocation map can be the offset frequency in multiple of the subcarrier spacing relative to the carrier frequency. For example, in the case of 128 FFT, the offset frequency can be in the range [−64, +64].

The physical layer parameter of a subcarriers allocated to a sub-channel can be adjacent in frequency or non-adjacent. The logical subcarriers (and/or the related frequency offsets) can be configured for each sub-channel. A non-adjacent frequency offset per sub-channel allocation can provide frequency diversity.

In some embodiments, data is transmitted and/or received in accordance with Table 1 as shown below

TABLE 1

| Parameter | Notation | Value |
|---|---|---|
| Nominal Channel Bandwidth | BW_{N} | 1 MHz |
| Sampling frequency (MHz) | F_{S} | 1.12 MHz |
| FFT size | | 128 |
| Subcarrier spacing (kHz) | BW_{SC} | 8.75 KHz |
| Subcarrier Allocation Scheme in | | AMC 2 × 3 and AMC 1 × 6 |
| downlink and in uplink | | |
| Subchannels in downlink and in | | 6 and 12 |
| uplink | | |
| Actual Bandwidth (centered on | BW_{A} | 945 KHz |
| nominal channel) for full channel | | |
| Actual Bandwidth (centered on | | 157.5 KHz |
| nominal channel) for single | | |
| subchannel with AMC 2 × 3 | | |
| Actual Bandwidth (centered on | | 78.75 KHz |
| nominal channel) for single | | |
| subchannel with AMC 1 × 6 | | |
| Preamble | | Preamble Off or standard |
| | | ieee802.16, 128 fft preamble |
| | | (transmitted over 33 |
| | | subcarriers). |
| CDMA Codes | | Standard ieee802.16, 128 fft |
| | | CDMA codes (transmitted over |
| | | 96 subcarriers) |
| Frame Size (ms) | | 5, 10, 12.5, 20, 25 |
| Number of samples per frame | N_{SaPF} | 5600 @ 5 ms, 11,200 @ 10 ms, |
| | | 14,000 @ 12.5 ms, 22,400 @ 20 ms, |
| | | 28,000 @ 25 ms |
| Number of symbols per frame | N_{SyPF} | Up to 38 for 5 ms frame, |
| | | Up to 77 for 10 ms frame, |
| | | Up to 97 for 12.5 ms frame, |
| | | Up to 155 for 20 ms frame, |
| | | Up to 194 for 25 ms frame |
| Number of samples per symbol | N_{SaPS} | 144 |
| Symbol duration (μs) | | 128.57 |
| Useful symbol duration (μs) | | 114.26 |
| Slot definition in downlink and in | | AMC 2 × 3: 1 SC × 3 symbols |
| uplink | | AMC 1 × 6: 1 SC × 6 symbols |
| Duplexing Mode | | TDD |

In some embodiments, data is transmitted and/or received in accordance with Table 2 as shown below:

TABLE 2

| Parameter | Notation | Value |
|---|---|---|
| Nominal Channel Bandwidth | BW_{N} | 500 Khz |
| Sampling frequency (MHz) | F_{S} | 1.12 MHz |
| FFT size | | 128 |
| Subcarrier spacing (kHz) | BW_{SC} | 8.75 KHz |
| Subcarrier Allocation Scheme in | | AMC 2 × 3 and AMC 1 × 6 |
| downlink and in uplink | | |
| Sub-channels in downlink and in uplink | | 3 for AMC 2 × 3 and 6 |
| | | for AMC 1 × 6 |
| Actual Bandwidth (centered on nominal | BW_{A} | 472.5 KHz |
| channel) for full channel | | |
| Actual Bandwidth (centered on nominal | | 157.5 KHz |
| channel) for single subchannel with | | |
| AMC 2 × 3 | | |
| Actual Bandwidth (centered on nominal | | 78.75 KHz |
| channel) for single subchannel with | | |
| AMC 1 × 6 | | |
| Preamble | | Preamble Off or |
| | | modified preamble |
| | | (e.g., transmitted over |
| | | 33 consecutive instead |
| | | of interleaved |
| | | subcarriers). |
| CDMA Codes | | Should be modified to |
| | | be transmitted over 54 |
| | | subcarriers only. |
| Frame Size (ms) | | 5, 10, 12.5, 20, 25 |
| Number of samples per frame | N_{SaPF} | 5600 @ 5 ms, 11,200 |
| | | @ 10 ms, 14,000 @ |
| | | 12.5 ms, 22,400 @ 20 ms, |
| | | 28,000 @ 25 ms |
| Number of symbols per frame | N_{SyPF} | Up to 38 for 5 ms |
| | | frame |
| | | Up to 77 for 10 ms |
| | | frame |
| | | Up to 97 for 12.5 ms |
| | | frame |
| | | Up to 155 for 20 ms |
| | | frame |
| | | Up to 194 for 25 ms |
| | | frame |
| Number of samples per symbol | N_{SaPS} | 144 |
| Symbol duration (μs) | | 128.57 |
| Useful symbol duration (μs) | | 114.26 |
| Slot definition in downlink and in uplink | | AMC 2 × 3: 1 SC × 3 |
| | | symbols |
| | | AMC 1 × 6: 1 SC × 6 |
| | | symbols |
| Duplexing Mode | | TDD |

In some embodiments, data is transmitted and/or received in accordance with Table 3 as shown below:

TABLE 3

| Parameter | Notation | Value |
|---|---|---|
| Nominal Channel Bandwidth | BW_{N} | 500 Khz |
| Sampling frequency (MHz) | F_{S} | 1.12 MHz |
| FFT size | | 128 |
| Subcarrier spacing (kHz) | BW_{SC} | 8.75 KHz |
| Subcarrier Allocation Scheme in | | AMC 1 × 6 |
| downlink and in uplink | | |
| Sub-channels in downlink and in | | 3 |
| uplink | | |
| Actual Bandwidth (centered on | BW_{A} | 236.25 KHz |
| nominal channel) for full channel | | |
| Actual Bandwidth (centered on | | 78.75 KHz |
| nominal channel) for single | | |
| subchannel with AMC 1 × 6 | | |
| Preamble | | Preamble Off or |
| | | modified preamble |
| | | transmitted over 27 |
| | | subcarriers |
| CDMA Codes | | Should be modified to |
| | | be transmitted over 27 |
| | | subcarriers only. |
| Frame Size (ms) | | 5, 10, 12.5, 20, 25 (*) |
| Number of samples per frame | | 5600 @ 5 ms, 11,200 |
| | | @ 10 ms, 14,000 @ |
| | | 12.5 ms, 22,400 @ |
| | | 20 ms, |
| | | 28,000 @ 25 ms |
| Number of symbols per frame | N_{SaPF} | Up to 38 for 5 ms |
| | | frame |
| | | Up to 77 for 10 ms |
| | | frame |
| | | Up to 97 for 12.5 ms |
| | | frame |
| | | Up to 155 for 20 ms |
| | | frame |
| | | Up to 194 for 25 ms |
| | | frame |
| Number of samples per symbol | N_{SyPF} | 144 |
| Symbol duration (μs) | N_{SaPS} | 128.57 |
| Useful symbol duration (μs) | | 114.26 |
| Slot definition in downlink and | | AMC 1 × 6: 1 SC × 6 |
| in uplink | | symbols |
| Duplexing Mode | | TDD |

In some embodiments, data is transmitted and/or received in accordance with Table 4 as shown below:

TABLE 4

| Parameter | Notation | Value |
|---|---|---|
| Nominal Channel Bandwidth | BW_{N} | 250 KHz |
| Sampling frequency (MHz) | F_{S} | 1.12 MHz |
| FFT size | | 128 |
| Subcarrier spacing (kHz) | BW_{SC} | 8.75 KHz |
| Subcarrier Allocation Scheme in | | AMC 1 × 6 |
| downlink and in uplink | | |
| Sub-channels in downlink and in | | 3 |
| uplink | | |
| Actual Bandwidth (centered on | BW_{A} | 236.25 KHz |
| nominal channel) for full channel | | |
| Actual Bandwidth (centered on | | 78.75 KHz |
| nominal channel) for single | | |
| subchannel with AMC 1 × 6 | | |
| Preamble | | Preamble Off or |
| | | modified preamble |
| | | transmitted over 27 |
| | | subcarriers |
| CDMA Codes | | Should be modified to |
| | | be transmitted over 27 |
| | | subcarriers only. |
| Frame Size (ms) | | 5, 10, 12.5, 20, 25 (*) |
| Number of samples per frame | | 5600 @ 5 ms, 11,200 |
| | | @ 10 ms, 14,000 @ |
| | | 12.5 ms, 22,400 @ |
| | | 20 ms, |
| | | 28,000 @ 25 ms |
| Number of symbols per frame | N_{SaPF} | Up to 38 for 5 ms |
| | | frame |
| | | Up to 77 for 10 ms |
| | | frame |
| | | Up to 97 for 12.5 ms |
| | | frame |
| | | Up to 155 for 20 ms |
| | | frame |
| | | Up to 194 for 25 ms |
| | | frame |
| Number of samples per symbol | N_{SyPF} | 144 |
| Symbol duration (μs) | N_{SaPS} | 128.57 |
| Useful symbol duration (μs) | | 114.26 |
| Slot definition in downlink and in | | AMC 1 × 6: 1 SC × 6 |
| uplink | | symbols |
| Duplexing Mode | | TDD |

In some embodiments, data is transmitted and/or received in accordance with Table 5 as shown below:

TABLE 5

| Parameter | Notation | Value |
|---|---|---|
| Nominal Channel Bandwidth | BW_{N} | 125 KHz |
| Sampling frequency (MHz) | F_{S} | 560 KHz |
| FFT size | | 128 |
| Subcarrier spacing (kHz) | BW_{SC} | 4.375 KHz |
| Subcarrier Allocation Scheme in | | AMC 1 × 6 |
| downlink and in uplink | | |
| Sub-channels in downlink and in | | 3 |
| uplink | | |
| Actual Bandwidth (centered on | BW_{A} | 118.125 KHz |
| nominal channel) for full channel | | |
| Actual Bandwidth (centered on | | 39.375 KHz |
| nominal channel) for single | | |
| subchannel with AMC 1 × 6 | | |
| Preamble | | Preamble Off or |
| | | modified preamble |
| | | transmitted over 27 |
| | | subcarriers |
| CDMA Codes | | Modified CDMA codes |
| | | transmitted over 27 |
| | | subcarriers |
| Frame Size (ms) | | 10, 12.5, 20, 25, 50 (*) |
| Number of samples per frame | | 5,600 @ 10 ms, 7,000 |
| | | @ 12.5 ms, 11,200 @ |
| | | 20 ms, 14,000 @ 25 ms, |
| | | 28,000 @ 50 ms |
| Number of symbols per frame | N_{SaPF} | Up to 38 for 10 ms |
| | | frame |
| | | Up to 77 for 20 ms |
| | | frame |
| | | Up to 97 for 25 ms |
| | | frame |
| | | Up to 194 for 50 ms |
| | | frame |
| Number of samples per symbol | N_{SyPF} | 144 |
| Symbol duration (μs) | N_{SaPS} | 257.14 μs |
| Useful symbol duration (μs) | | 228.57 μs |
| Slot definition in downlink and in | | AMC 1 × 6: 1 SC × 6 |
| uplink | | symbols |
| Duplexing Mode | | TDD |

In some embodiments, data is transmitted and/or received in accordance with Table 6 as shown below:

TABLE 6

| Parameter | Notation | Value |
|---|---|---|
| Nominal Channel Bandwidth | BW_{N} | 100 KHz |
| Sampling frequency (MHz) | F_{S} | 448 KHz |
| FFT size | | 128 |
| Subcarrier spacing (kHz) | BW_{SC} | 3.5 KHz |
| Subcarrier Allocation Scheme in | | AMC 1 × 6 |
| downlink and in uplink | | |
| Sub-channels in downlink and in | | 3 |
| uplink | | |
| Actual Bandwidth (centered on | BW_{A} | 94.5 KHz |
| nominal channel) for full channel | | |
| Actual Bandwidth (centered on | | 31.5 KHz |
| nominal channel) for single | | |
| subchannel with AMC 1 × 6 | | |
| Preamble | | Preamble Off or |
| | | modified preamble |
| | | transmitted over 27 |
| | | subcarriers |
| CDMA Codes | | Modified CDMA codes |
| | | transmitted over 27 |
| | | subcarriers |
| Frame Size (ms) | | 12.5, 20, 25, 50 (*) |
| Number of samples per frame | | 5,600 @ 12.5 ms, |
| | | 8,960 @ 20 ms, |
| | | 11,200 @ 25 ms, |
| | | 24,400 @ 50 ms |
| Number of symbols per frame | N_{SaPF} | Up to 38 for 12.5 ms |
| | | frame |
| | | Up to 62 for 20 ms |
| | | frame |
| | | Up to 77 for 25 ms |
| | | frame |
| | | Up to 169 for 50 ms |
| | | frame |
| Number of samples per symbol | N_{SyPF} | 144 |
| Symbol duration (μs) | N_{SaPS} | 321.43 μs |
| Useful symbol duration (μs) | | 285.71 μs |
| Slot definition in downlink and in | | AMC 1 × 6: 1 SC × 6 |
| uplink | | symbols |
| Duplexing Mode | | TDD |

In the preceding description, various aspects of the invention are described. For purposes of explanation, specific configurations and details are set forth in order to provide a thorough understanding of the invention. However, it is apparent to one skilled in the art that the present invention can be practiced without the specific details presented herein. Furthermore, well known features can be omitted or simplified in order not to obscure the invention.

Unless specifically stated otherwise, as apparent from the preceding discussions, it is appreciated that throughout the specification discussions utilizing terms such as “processing”, “computing”, “storing”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Different embodiments are disclosed herein. Features of certain embodiments can be combined with features of other embodiments; thus certain embodiments can be combinations of features of multiple embodiments.

Embodiments of the invention can include an article such as a computer or processor readable non-transitory storage medium, such as for example a memory, a disk drive, or a USB flash memory encoding, including or storing instructions, e.g., computer-executable instructions, which when executed by a processor or controller, cause the processor or controller to carry out methods disclosed herein. In some embodiments, a computer processor or computer controller, e.g., data processor, can be configured to carry out embodiments of the invention, for example by executing software or code stored in a memory connected to the processor, and/or by having dedicated circuitry.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

We claim:

1. An internet protocol (IP) based communication system for transmitting and receiving data on a broadband wireless network, the system comprising:
at least one base station capable of transmitting and receiving data the data encapsulated in Time Division Duplex (TDD) frames and represented by Orthogonal Frequency Division Multiple Access (OFDMA) symbols, wherein said base station transmits data in a downlink sub-frame of one or more of the TDD frames and receives data in carried in an uplink sub-frame of one or more of the TDD frames; and
a plurality of remote stations capable of communicating data with the at least one base station, wherein said remote stations transmit data to said at least one base station in the uplink sub-frame of one or more of the TDD frames and receive data from said at least one base station in the downlink sub-frame of one or more the TDD frames; and
wherein said at least one base station and each of said plurality of remote stations are configured to communicate using a nominal channel bandwidth of less than 1.25 Megahertz.

2. The IP based communication system of claim 1 wherein for at least one of the TDD frames a downlink duration for its corresponding downlink sub-frame is at least two times an uplink duration for its corresponding uplink sub-frame.

3. The IP based communication system of claim 1 wherein for at least one of the TDD frames an uplink duration for its corresponding uplink sub-frame is at least two times a downlink duration for its corresponding downlink sub-frame.

4. The IP based communication system of claim 1 wherein the data is transmitted and received such that:
i) a number of active subcarriers is minimized such that the pilot subcarrier spacing is less than or equal to the coherent bandwidth, wherein the coherent bandwidth is based on the a delay spread of the channel, and
ii) a percentage of pilot subcarriers relative to a total number of subcarriers should be low to avoid excessive overhead.

5. The IP based communication system of claim 3 wherein a total number of active subcarriers is based on the total number of subcarriers, minus a number of guard subcarriers on a left edge of the channel, and minus a number of guard subcarriers on a right edge of the channel.

6. The IP based communication system of claim 4 wherein the number of guard subcarriers on the left edge of the channel and the number of guard subcarriers on the right edge of the channel is based on one or more spectrum emission requirements.

7. The IP based communication system of claim 1 wherein the data is transmitted and received with a sampling frequency that results in a number of samples per TDD frame being an integer.

8. The IP based communication system of claim 1 wherein the data is transmitted and received such that a subcarrier spacing is less than a delay spread of the channel

9. The IP based communication system of claim 1 wherein frame duration for the TDD frames is based on a desired latency and a desired throughput.

10. The IP based communication system of claim 1 wherein a minimum number of frames needed to fit in an integer multiple of one second is based on aligning a beginning of the TDD frames with a GPS.
